(19) United States
(12) Patent Application Publication
(10) Pub. No.: US 2025/0259040 A1
(43) Pub. Date: Aug. 14, 2025

(54) METHOD AND COMPUTER PROGRAM FOR PERFORMING PROCESSING RELATED TO CLASS DISCRIMINANT MODEL INCLUDING GAP LAYER

(71) Applicant: SEIKO EPSON CORPORATION, TOKYO (JP)

(72) Inventor: Hikaru KURASAWA, Matsumoto-shi (JP)

(21) Appl. No.: 19/050,535

(22) Filed: Feb. 11, 2025

(30) Foreign Application Priority Data
Feb. 13, 2024 (JP) 2024-019114

(51) Int. Cl. G06N 3/0464

(52) U.S. Cl. CPC G06N 3/0464

(57) ABSTRACT

A method of the present disclosure includes (a) a step for inputting input data to a class discriminant model to obtain an operation result of the class discriminant model, (b) a step for extracting a plurality of feature vectors in a plurality of partial regions constituting an immediately preceding layer disposed immediately before a GAP layer, and a GAP layer vector being output of the GAP layer, and (c) a step for calculating a degree of contribution of each of the plurality of partial regions related to a direction of the GAP layer vector using the plurality of feature vectors and the GAP layer vector.

The present application is based on, and claims priority from JP Application Serial Number 2024-019114, filed Feb. 13, 2024, the disclosure of which is hereby incorporated by reference herein in its entirety.

### BACKGROUND

### 1. Technical Field

The present disclosure relates to a method and a computer program for performing processing related to a class discriminant model including a GAP layer.

### 2. Related Art

W. Yang, et al., “Towards Rich Feature Discovery With Class Activation Maps Augmentation for Person Re-Identification”, in 2019 IEEE/CVF Conference on Computer Vision and Pattern Recognition (CVPR) discloses a method for calculating a degree of contribution of a feature vector in a preceding layer of a global average pooling (GAP) layer of a deep learning model to the GAP layer. In this existing technique, a tensor extracted from the preceding layer of the GAP layer is divided into a plurality of feature vectors corresponding to a plurality of portions constituting the layer. Then, a product of a cosine similarity between each feature vector and the GAP layer vector and a norm of each feature vector is calculated as a degree of contribution of a corresponding portion. This makes it possible to quantify a degree of contribution of a feature vector of each portion of the preceding layer to magnitude of the GAP layer vector.

In the existing technique described above, the degree of contribution of the feature vector of each portion of the preceding layer to the magnitude of the GAP layer vector is obtained. However, in a class discriminant problem, since a direction of the GAP layer vector is reflected in a class discriminant result, it is desired to know not the degree of contribution to the magnitude of the GAP layer vector but a degree of contribution to the direction of the GAP layer vector.

### SUMMARY

According to a first aspect of the present disclosure, there is provided a method for performing processing related to a class discriminant model including a GAP layer. This method includes (a) a step for inputting input data to the class discriminant model to obtain an operation result of the class discriminant model, (b) a step for extracting a plurality of feature vectors in a plurality of partial regions constituting an immediately preceding layer disposed immediately before the GAP layer, and a GAP layer vector being output of the GAP layer, and (c) a step for calculating a degree of contribution of each of the plurality of partial regions related to a direction of the GAP layer vector using the plurality of feature vectors and the GAP layer vector.

According to a second aspect of the present disclosure, there is provided a computer program causing a processor to perform processing related to a class discriminant model including a GAP layer. This computer program causes the processor to perform (a) processing for inputting input data to the class discriminant model to obtain an operation result of the class discriminant model, (b) processing for extracting a plurality of feature vectors in a plurality of partial regions constituting an immediately preceding layer disposed immediately before the GAP layer, and a GAP layer vector being output of the GAP layer, and (c) processing for calculating a degree of contribution of each of the plurality of partial regions related to a direction of the GAP layer vector using the plurality of feature vectors and the GAP layer vector.

### BRIEF DESCRIPTION OF THE DRAWINGS

FIG. 1 is a block diagram of an information processing device in an embodiment.

FIG. 2 is an explanatory diagram illustrating a relationship between a class discriminant model and a contribution degree map creation unit.

FIG. 3 is an explanatory diagram illustrating a configuration of an immediately preceding layer and a GAP layer.

FIG. 4 is a flowchart illustrating a processing procedure of the embodiment.

FIG. 5 is a flowchart illustrating a detailed procedure of step S40.

FIG. 6 is an explanatory diagram illustrating a display example of a contribution degree map.

### DESCRIPTION OF EMBODIMENTS

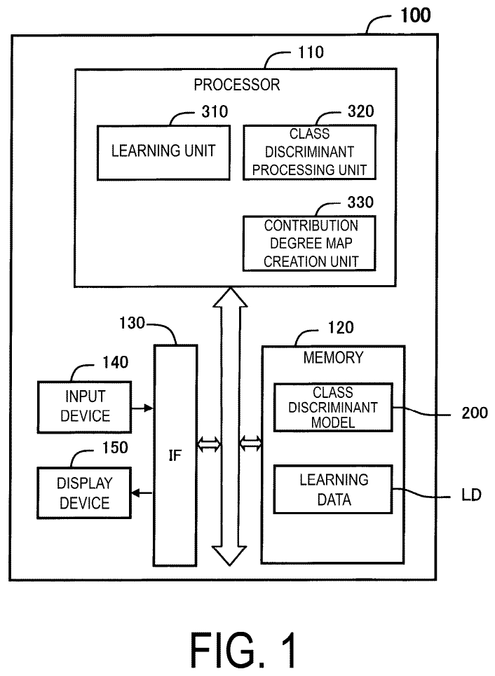

FIG. 1 is a block diagram illustrating functions of an information processing device 100 in an embodiment. The information processing device 100 includes a processor 110, a memory 120, an interface circuit 130, and an input device 140 and a display device 150 coupled to the interface circuit 130. The processor 110 not only has a function of performing processing described in detail below, but also has a function of displaying data obtained by the processing and data generated in a process of the processing on the display device 150. The information processing device 100 can be achieved by a computer such as a personal computer.

The processor 110 achieves functions of a learning unit 310 that performs learning of a class discriminant model 200, a class discriminant processing unit 320 that performs class discriminant processing of input data using the class discriminant model 200, and a contribution degree map creation unit 330 that creates a contribution degree map to be described later. The functions of these units are achieved by the processor 110 executing a computer program stored in the memory 120. However, the functions of these units may be achieved by a hardware circuit. The processor in this specification is a term including such a hardware circuit. In addition, one or more processors that perform various kinds of processing may be processors included in one or more remote computers connected via a network.

The memory 120 stores the class discriminant model 200 and learning data LD thereof. The class discriminant model 200 is used for operation by the class discriminant processing unit 320. The learning data LD is labeled data used for learning of the class discriminant model 200.

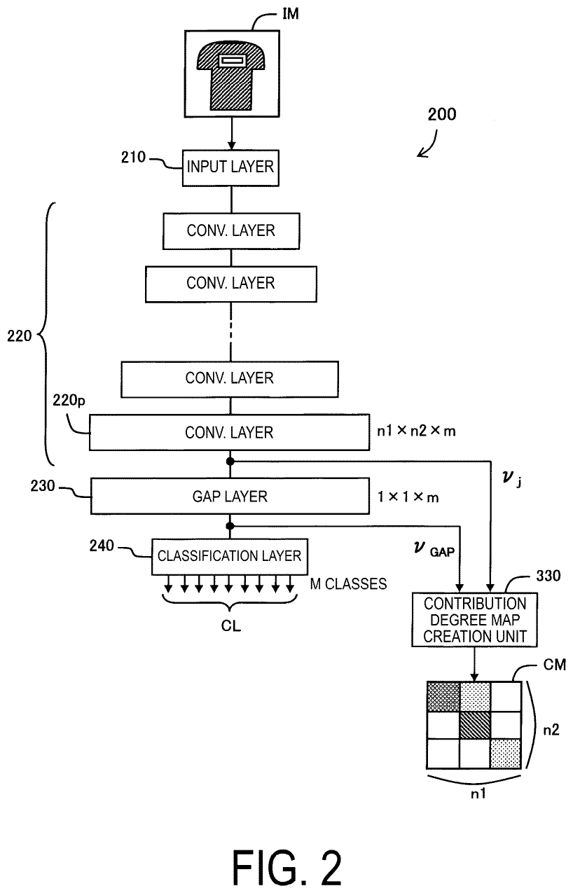

FIG. 2 is an explanatory diagram illustrating a relationship between the class discriminant model 200 and the contribution degree map creation unit 330. The class discriminant model 200 includes an input layer 210 to which input data IM is input, a plurality of convolution layers 220, a global average pooling (GAP) layer 230, and a classification layer 240. The input data IM is typically image data. As the class discriminant model 200, for example, ResNet, WideResNet or the like can be used. However, data other than an image may be used as the input data IM. For example, an audio signal, one-dimensional data such as a spectroscopic spectrum, surface spectroscopic data, or the like may be used as the input data IM. The surface spectroscopic data is an image having more than three channels.

Among the plurality of convolution layers 220, a layer disposed immediately before the GAP layer 230 is referred to as an “immediately preceding layer 220p”. When an output size of each layer is expressed as “width×height×channel depth”, the immediately preceding layer 220p has a size of n1×n2×m, and the GAP layer 230 has a size of 1×1×m. Here, one of n1 and n2 is an integer equal to or greater than 1, and another is an integer equal to or greater than 2, and m is an integer equal to or greater than 2. For example, when the input data IM is one-dimensional data, one of n1 and n2 may be equal to 1. Note that the immediately preceding layer 220p need not be a convolution layer, and may be, for example, a residual layer.

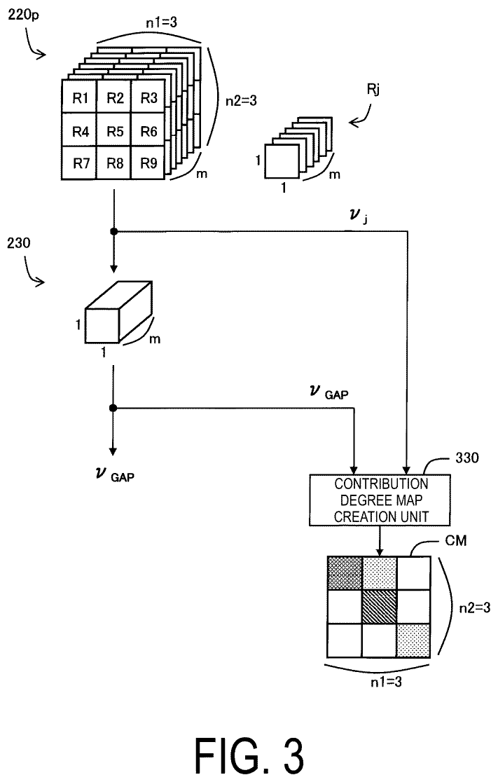

FIG. 3 is an explanatory diagram illustrating a configuration of the immediately preceding layer 220p and the GAP layer 230. The immediately preceding layer 220p includes n1×n2 partial regions Rj. Here, j is an ordinal number from 1 to n1×n2. The individual partial regions Rj each have a size of 1×1×m. In the example of FIG. 3, since n1=n2=3, the immediately preceding layer 220p includes nine partial regions R1 to R9. Output of each partial region Rj is referred to as a “feature vector νⱼ”. The feature vector νⱼ is an m-dimensional vector. In other words, a tensor of n1×n2×m, which is output of the immediately preceding layer 220, includes n1×n2 feature vectors νⱼ.

The GAP layer 230 performs global average pooling processing on the output of the immediately preceding layer 220p to obtain a GAP layer vector ν_{GAP} which is output of the GAP layer 230. The global average pooling processing is processing for obtaining an average of n1×n2 outputs for each of the m channels of the immediately preceding layer 220. The GAP layer vector ν_{GAP} is an average vector of the n1×n2 feature vectors νⱼ, and is an m-dimensional vector.

When the number of discriminable classes is M, the classification layer 240 outputs a class discriminant result CL indicating which of the M classes a class is. The number of classes M is equal to or greater than 2, and may be equal to or greater than 3. The classification layer 240 includes a fully coupled layer, and converts elements {v1, v2, . . . , vm} of the GAP layer vector ν_{GAP} into M values by linear conversion using weight of the fully coupled layer to generate the class discriminant result CL. Therefore, there is a tendency that a ratio of magnitude of each of the elements {v1, v2, . . . , vm} of the GAP layer vector ν_{GAP} has a larger influence on the class discriminant result CL than magnitude of a norm of the GAP layer vector ν_{GAP}. This tendency is the same when the class discriminant result CL is generated by applying a softmax function to a result of the linear conversion using the weight of the fully coupled layer. The ratio of the magnitude of each of the elements {v1, v2, . . . , vm} of the GAP layer vector ν_{GAP} corresponds to a direction of the GAP layer vector ν_{GAP}. In this way, the direction of the GAP layer vector ν_{GAP} has a larger influence on the class discriminant result CL than the magnitude of the norm of the GAP layer vector ν_{GAP}, thus in the embodiment, a degree of contribution of each partial region Rj of the immediately preceding layer 220p to the direction of the GAP layer vector ν_{GAP} is obtained.

The contribution degree map creation unit 330 creates a contribution degree map CM representing a degree of contribution of each of the plurality of partial regions Rj with respect to the direction of the GAP layer vector ν_{GAP} by using a plurality of feature vectors νⱼ which are output of the plurality of partial regions Rj and the GAP layer vector ν_{GAP} which is output of the GAP layer 230. The contribution degree map CM has a size of n1×n2.

As described above, the output of the immediately preceding layer 220p includes the n1×n2 feature vectors νⱼ, and the GAP layer vector ν_{GAP} is an average vector of the n1×n2 feature vectors νⱼ. Therefore, when the degree of contribution of the feature vector νⱼ of the individual partial region Rj to the direction of the GAP layer vector ν_{GAP} is known, the degree of contribution can be read as a degree of contribution of a specific portion of the input data IM corresponding to the partial region Rj. The degree of contribution of each partial region Rj is calculated as follows.

The GAP layer vector ν_{GAP} is given by the following equation.

$$[ Math 1 ]$$

$$[ Math . 1 ]$$

$${v}_{GAP} = \frac{1}{N} {\sum }_{V} {v}_{j} \qquad ( q1 )$$

Here, νⱼ is the feature vector of the partial region Rj, V is a set of the feature vectors νⱼ corresponding to all the partial regions Rj of the immediately preceding layer 220p, N is the number of partial regions Rj, and N=n1×n2.

In the embodiment, in order to calculate an extent of contribution of the individual partial region Rj to the direction of the GAP layer vector ν_{GAP}, a partial region GAP vector ν_{SR-i} with respect to an i-th partial region Ri is calculated according to the following equation.

$$[ Math 2 ]$$

$$[ Math . 2 ]$$

$${v}_{SRi} = \frac{1}{N} {\sum }_{V \backslash {v}_{i}} {v}_{j} \qquad ( q2 )$$

Here, a symbol “V\νᵢ” attached to a summation symbol Σ means a set obtained by excluding an i-th feature vector νᵢ from the set V of all the feature vectors of the immediately preceding layer 220p.

In other words, the partial region GAP vector ν_{SR-i} is calculated by performing the global average pooling processing on output of the immediately preceding layer 220p in a state where the i-th feature vector νᵢ is replaced with a zero vector.

A degree of contribution Ci of the i-th partial region Ri to the direction of the GAP layer vector ν_{GAP} can be calculated, for example, as follows.

### [Math 3]

$$[ Math . 3 ]$$

$${c}_{i} = 1 - D \qquad ( q3 )$$

$$D = \frac{{v}_{GAP} \cdot {v}_{SRi}}{‖ {v}_{GAP} ‖ ‖ {v}_{SRi} ‖} \qquad ( q4 )$$

Here, D is a cosine similarity between the GAP layer vector ν_{GAP} and the partial region GAP vector ν_{SR-i}. In other words, the degree of contribution Ci of the i-th partial region Ri can be calculated by subtracting the cosine similarity degree D between the GAP layer vector ν_{GAP} and the partial region GAP vector ν_{SR-i} from 1.

The cosine similarity D between the GAP layer vector ν_{GAP} and the partial region GAP vector ν_{SR-i} serves as an index indicating how much the partial region GAP vector ν_{SR-i} obtained when the feature vector νᵢ of the i-th partial region Ri is replaced with the zero vector has changed from the GAP layer Vector ν_{GAP}. When the i-th partial region Ri has no influence on the class discriminant result CL, the partial region GAP vector ν_{SR-i} is equal to the GAP layer vector ν_{GAP}, and the cosine similarity D is 1, so that the degree of contribution Ci is 0. On the other hand, when the information of the i-th partial region Ri is all of the GAP layer vector ν_{GAP}, the partial region GAP vector ν_{SR-i} becomes the zero vector and the cosine similarity D becomes 0, so that the degree of contribution Ci becomes 1. Therefore, the degree of contribution Ci serves as an index indicating an extent of contribution of the i-th partial region Ri to the direction of the GAP layer vector ν_{GAP}.

Note that the degree of contribution Ci may be calculated by an equation other than the above equation (q3), and may be calculated by any one of the following equations, for example.

### [Math 4]

$$[ Math . 4 ]$$

$${c}_{i} = a ( 1 - D ) \qquad ( q5 )$$

$${c}_{i} = - aD \qquad ( q6 )$$

$${c}_{i} = a ( \frac{2}{1 + D} - 1 ) \qquad ( q7 )$$

Here, a is a positive coefficient, and D is the cosine similarity between the GAP layer vector ν_{GAP} and the partial region GAP vector ν_{SR-i}. The above equation (q3) corresponds to an equation when a=1 in the above equation (q5).

Generally, the degree of contribution Ci may have a negative correlation with the cosine similarity D between the GAP layer vector ν_{GAP} and the partial region GAP vector ν_{SR-i}. Further, the degree of contribution Ci may be represented by a function uniquely determined according to the cosine similarity degree D. Any of the degrees of contribution Ci given by the above equations (q3) to (q7) has a negative correlation with the cosine similarity degree D and is represented by a function uniquely determined according to the cosine similarity degree D. However, it is sufficient that the degree of contribution Ci has a negative correlation with the cosine similarity degree D, and the degree of contribution Ci may be calculated using an equation other than the above equations (q3) to (q7). In this way, the degree of contribution Ci indicating the extent of contribution of the i-th partial region Ri to the direction of the GAP layer vector ν_{GAP} can be obtained.

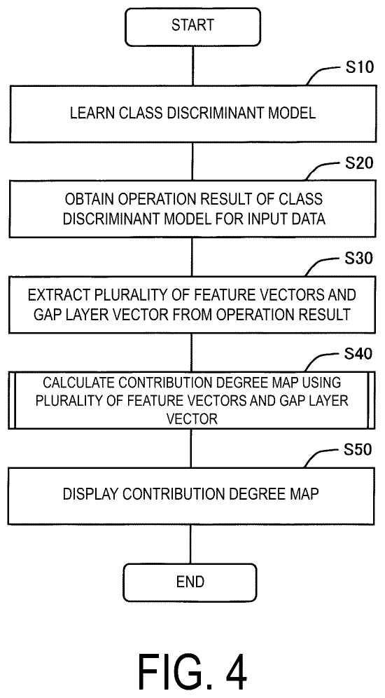

FIG. 4 is a flowchart illustrating a processing procedure of the embodiment. In step S10, the learning unit 310 performs machine learning of the class discriminant model 200 using the learning data LD. In step S20, the class discriminant processing unit 320 inputs the input data IM to the class discriminant model 200 to obtain an operation result of the class discriminant model 200.

In step S30, the contribution degree map creation unit 330 extracts the feature vectors νⱼ of the plurality of partial regions Rj constituting the immediately preceding layer 220p and the gap layer vector ν_{GAP} which is the output of the gap layer 230 from the operation result of the class discriminant model 200. At this time, the correspondence relationship between the feature vector νⱼ and the partial region Rj is also stored. In step S40, the contribution degree map creation unit 330 calculates a contribution degree map using the plurality of feature vectors νⱼ and the GAP layer vector ν_{GAP}.

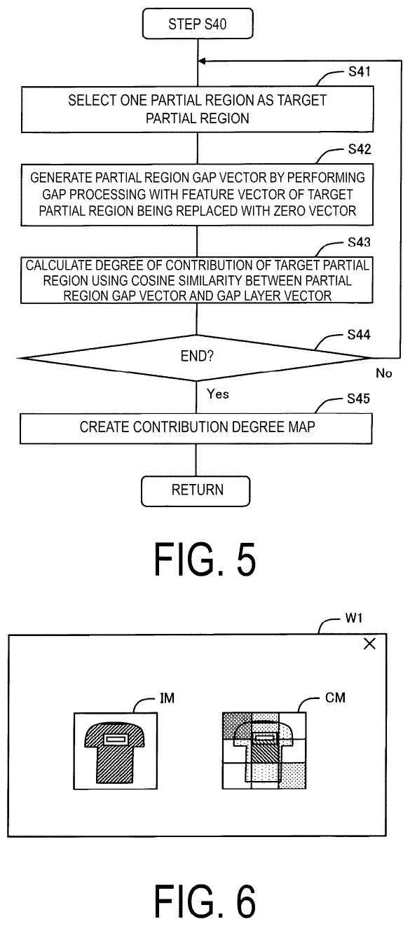

FIG. 5 is a flowchart illustrating a detailed procedure of step S40. In step S41, the contribution degree map creation unit 330 selects one partial region Ri as a target partial region. In step S42, the contribution degree map creation unit 330 generates the partial region GAP vector ν_{SR-i} by performing the global average pooling processing on output of the immediately preceding layer 220p in a state where the feature vector νᵢ of the target partial region Ri is replaced with the zero vector. This processing is performed in accordance with the above equation (q2). In step S43, the contribution degree map creation unit 330 calculates the degree of contribution Ci of the target partial region Ri using the cosine similarity D between the partial region GAP vector ν_{SR-i} and the GAP layer vector ν_{GAP}. This processing is performed in accordance with, for example, the above equation (q3). In step S44, the contribution degree map creation unit 330 determines whether the processing in steps S41 to S43 is completed for all the partial regions Rj or not. When the processing is not completed for all the partial regions Rj, the processing returns to step S41, a new partial region Rj is selected as the target partial region Ri, and the processing in steps S42 to S43 is performed again. On the other hand, when the processing is completed for all the partial regions Rj, the processing proceeds to step S45, and the contribution degree map creation unit 330 creates the contribution degree map CM illustrated in FIG. 3.

When the processing of step S40 is completed in this way, the processing proceeds to step S50 in FIG. 4, and the contribution degree map creation unit 330 displays the contribution degree map CM on the display device 150.

FIG. 6 is an explanatory diagram illustrating a display example of the contribution degree map CM. In this example, an image of the input data IM and the contribution degree map CM are displayed in a display window W1. The contribution degree map CM has a size of n1×n2, which is the same size as that of the immediately preceding layer 220p. Although the input data IM has a larger planar size than that of the immediately preceding layer 220p, size adjustment may be performed at the time of display such that visual sizes of both the input data IM and the immediately preceding layer 220p are equal to each other.

In the example of FIG. 6, the contribution degree map CM is displayed as a heat map, and the image of the input data IM is displayed in a state of being superimposed on the contribution degree map CM. At this time, by setting a transmittance for the input data IM, it is possible to check a state in which the contribution degree map CM and the input data IM are superimposed on each other. A user can visually recognize which portion of the image of the input data IM has a large influence on the class discriminant result CL by observing such a contribution degree map CM.

As described above, in the embodiment, the degree of contribution Ci of each of the plurality of partial regions Rj with respect to the direction of the GAP layer vector ν_{GAP} is calculated using the plurality of feature vectors νⱼ of the plurality of partial regions Rj constituting the immediately preceding layer 220p of the GAP layer 230 and the GAP layer vector ν_{GAP} which is the output of the GAP layer 230. Therefore, the degree of contribution Ci that contributes to the direction of the GAP layer vector ν_{GAP} can be obtained for each of the plurality of partial regions Rj constituting the immediately preceding layer 220p.

### OTHER EMBODIMENTS

The present disclosure is not limited to the embodiments described above, and may be achieved in various aspects without departing from the spirits of the disclosure. For example, the present disclosure can also be achieved by the following aspects. Appropriate replacements or combinations may be made to the technical features in the above-described embodiments which correspond to the technical features in the aspects described below to solve some or all of the problems of the disclosure or to achieve some or all of the advantageous effects of the disclosure. Furthermore, when the technical characteristics are not described as being essential in the present specification, the technical characteristics can be deleted as appropriate.

(1) According to the first aspect of the present disclosure, there is provided a method for performing processing related to a class discriminant model including a GAP layer. This method includes (a) a step for inputting input data to the class discriminant model to obtain an operation result of the class discriminant model, (b) a step for extracting a plurality of feature vectors in a plurality of partial regions constituting an immediately preceding layer disposed immediately before the GAP layer, and a GAP layer vector being output of the GAP layer, and (c) a step for calculating a degree of contribution of each of the plurality of partial regions related to a direction of the GAP layer vector using the plurality of feature vectors and the GAP layer vector.

According to this method, the degree of contribution to the direction of the GAP layer vector can be obtained for each of the plurality of partial regions constituting the immediately preceding layer of the GAP layer.

(2) In the above method, when one of n1 and n2 is an integer equal to or greater than 1 and another is an integer equal to or greater than 2, m is an integer equal to or greater than 2, and a size of output of the immediately preceding layer is expressed by “width×height×channel depth”, the immediately preceding layer may have a size of n1×n2×m, each of the plurality of partial regions may have a size of 1×1×m, and each of the plurality of feature vectors and the GAP layer vector may be an m-dimensional vector.

According to this method, the degree of contribution to the direction of the GAP layer vector can be obtained for each partial region having the size of 1×1×m.

(3) In the above method, step (c) may include (c1) a step for sequentially selecting one of the plurality of partial regions as a target partial region, (c2) a step for generating a partial region GAP vector by performing global average pooling processing on output of the immediately preceding layer in a state where the feature vector in the target partial region is replaced with a zero vector, and (c3) a step for calculating the degree of contribution of the target partial region using a cosine similarity between the partial region GAP vector and the GAP layer vector.

According to this method, the degree of contribution of each partial region can be calculated using the cosine similarity between the partial region GAP vector and the GAP layer vector.

(4) In the above method, the degree of contribution may have a negative correlation with the cosine similarity, and may be represented by a function that is uniquely determined in accordance with the cosine similarity.

According to this method, it is possible to obtain the degree of contribution that indicates an extent of contribution of the individual partial region to the direction of the GAP layer vector.

(5) In the above method, step (c3) may include a step for obtaining the degree of contribution by subtracting the cosine similarity from 1.

According to this method, the degree of contribution having a value in a range of 0 to 1 can be obtained.

(6) According to the second aspect of the present disclosure, there is provided a computer program causing a processor to perform processing related to a class discriminant model including a GAP layer. This computer program causes the processor to perform (a) processing for inputting input data to the class discriminant model to obtain an operation result of the class discriminant model, (b) processing for extracting a plurality of feature vectors in a plurality of partial regions constituting an immediately preceding layer disposed immediately before the GAP layer, and a GAP layer vector being output of the GAP layer, and (c) processing for calculating a degree of contribution of each of the plurality of partial regions related to a direction of the GAP layer vector using the plurality of feature vectors and the GAP layer vector.

The present disclosure may also be achieved by various aspects other than the above. For example, the present disclosure can be achieved by aspects such as a class classification device, a computer program for achieving functions thereof, and a non-transitory storage medium storing the computer program.

What is claimed is:

1. A method for performing processing related to a class discriminant model including a GAP layer, comprising:
(a) inputting input data to the class discriminant model to obtain an operation result of the class discriminant model;
(b) extracting a plurality of feature vectors in a plurality of partial regions constituting an immediately preceding layer disposed immediately before the GAP layer, and a GAP layer vector being output of the GAP layer from the operation result; and
(c) calculating a degree of contribution of each of the plurality of partial regions related to a direction of the GAP layer vector using the plurality of feature vectors and the GAP layer vector.

2. The method according to claim 1, wherein
when one of n1 and n2 is an integer equal to or greater than 1 and another is an integer equal to or greater than 2, m is an integer equal to or greater than 2, and a size of output of the immediately preceding layer is expressed by “width×height×channel depth”, the immediately preceding layer has a size of n1×n2×m,
each of the plurality of partial regions has a size of 1×1×m, and
each of the plurality of feature vectors and the GAP layer vector is an m-dimensional vector.

3. The method according to claim 2, wherein
(c) includes
(c1) sequentially selecting one of the plurality of partial regions as a target partial region,
(c2) generating a partial region GAP vector by performing global average pooling processing on output of the immediately preceding layer in a state where the feature vector in the target partial region is replaced with a zero vector, and
(c3) calculating the degree of contribution of the target partial region using a cosine similarity between the partial region GAP vector and the GAP layer vector.

4. The method according to claim 3 wherein
the degree of contribution has a negative correlation with the cosine similarity, and is represented by a function that is uniquely determined in accordance with the cosine similarity.

5. The method according to claim 3, wherein
(c3) includes obtaining the degree of contribution by subtracting the cosine similarity from 1.

6. A non-transitory computer-readable storage medium storing a computer program causing a processor to perform processing related to a class discriminant model including a GAP layer, the computer program being configured to cause the processor to perform:
(a) processing for inputting input data to the class discriminant model to obtain an operation result of the class discriminant model;
(b) processing for extracting a plurality of feature vectors in a plurality of partial regions constituting an immediately preceding layer disposed immediately before the GAP layer, and a GAP layer vector being output of the GAP layer; and
(c) processing for calculating a degree of contribution of each of the plurality of partial regions related to a direction of the GAP layer vector using the plurality of feature vectors and the GAP layer vector.
